(19) United States
(12) Patent Application Publication
(10) Pub. No.: US 2020/0163009 A1
(43) Pub. Date: May 21, 2020

(54) AMF ELIGIBILITY FOR RELAY AND REROUTE

(71) Applicant: Telefonaktiebolaget LM Ericsson (publ), Stockholm (SE)

(72) Inventors: Qian Chen, Mölndal (SE); Paul Schliwa-Bertling, Ljungsbro (SE); Peter Ramle, Mölnlycke (SE); Josefin Karlsson, Torslanda (SE); Peter Hedman, Helsingborg (SE)

(21) Appl. No.: 16/609,285

(22) PCT Filed: May 9, 2018
(86) PCT No.: PCT/EP2018/061980

§ 371 Date: Oct. 29, 2019

Related U.S. Application Data
(60) Provisional application No. 62/503,764, filed on May 9, 2017.

(51) Int. Cl. H04W 48/18; H04W 76/10

(52) U.S. Cl. CPC H04W 48/18; H04W 76/10

(57) ABSTRACT

Disclosed herein is a core network entity and a method of operation of a core network entity in a wireless communication network, comprising: receiving an establishment request message from a Radio Access Network (RAN) node; and sending an establishment response message to the RAN node where the establishment response message comprises an indication of a relay capability of the core network entity.

### TECHNICAL FIELD

The present disclosure relates generally to relaying information in Fifth Generation Core Networks (5GCs).

### BACKGROUND

As part of the Fifth Generation (5G) work in Third Generation Partnership Project (3GPP), it has been agreed that a “CM-Connected and Radio Resource Control (RRC) inactive” state will be introduced. At this state, User Equipment (UE) reachability is managed by Radio Access Nodes (RAN). See below table from TR 23.799:

The following table documents the current status of agreements on the Core Network (CN)-RAN functional allocation:

TABLE 8.8.1-1
Logical function allocation

| | Location: | | |
|---|---|---|---|
| | NextGen | NextGen | |
| Function: | RAN | CN | Comments |
| Key Issue #1 - Network Slicing | | | |
| CN instance selection when UE | For | FFS | |
| attaches to a CN network slice | Further | | |
| | Study | | |
| | (FFS) | | |
| Key Issue #3 - Mobility Management | | | |
| Mobility management control, | | X | |
| (Subscription and Policies) | | | |
| Determination of mobility restriction | | X | |
| Roaming restrictions execution | | X | |
| Mobility restrictions execution, [CN | X | | |
| Connected] | | | |
| Mobility restrictions execution, [CN Idle] | | X | It is expected that the RAN |
| | | | design will enable |
| | | | minimization of CN-initiated |
| | | | paging and UE associated |
| | | | CN/RAN signalling |
| UE registration | | X | |
| Area tracking | FFS | X | The need for RAN level area |
| | | | tracking is for RAN Working |
| | | | Groups (WGs) to determine. |
| UE unreachability detection | | X | Assumed to be supported in |
| | | | CN for UEs in CN Idle state. |
| RAN UE unreachability detection | X | | Assumed to be supported in |
| | | | RAN for UEs in RAN Inactive |
| | | | state. If RAN inactive state |
| | | | exists. |
| Non-Access Stratum (NAS) state | | X | |
| transitions | | | |
| RRC state transitions | X | | |
| Paging initiation and control in RAN | X | | RAN Inactive state is RAN |
| Inactive state | | | state that corresponds to CN |
| | | | connected state. If RAN |
| | | | inactive state exists. |
| Paging initiation in CN Idle state | | X | |
| Access Stratum UE Context storage in | X | | If RAN inactive state exists. |
| RAN Inactive state | | | |
| Control of connected state mobility | X | X | |
| User Plane (UP) buffer for UE in CN | | X | |
| Idle state | | | |
| UP buffer for UE in RAN Inactive state | X | | If RAN inactive state exists. |
| Key Issue #4 - Session Management | | | |
| PDU Session address allocation | | X | FFS for non- Internet |
| | | | Protocol (IP) Protocol Data |
| | | | Unit (PDU) Sessions |
| PDU Session Termination Point | | X | Note that this refers to the |
| | | | ownership of the specification |
| | | | for the function supporting |
| | | | the termination point. In a |
| | | | NW deployment this function |
| | | | may be deployed on or close |
| | | | to a RAN site. |
| Session Management | | X | |
| Termination of UP security | FFS | FFS | FFS |
| Subscription Data Handling (incl. | | X | |
| default Quality of Service (QoS) profile) | | | |
| Key issue #12 | | | |
| Authentication and Key Agreement | | X | |
| Key Issue #2 QoS | | | |
| Radio Resource Admission Control | X | | |
| Radio Resource management (QoS | X | | Packet scheduling with |
| attributes) | | | regards to resource utilization |
| | | | and availability (Radio |
| | | | Resource Management |
| | | | (RRM)) |
| Max rate control | X | X | Maximum bitrate policing in |
| | | | the CN and RAN in UL and |
| | | | DL. |
| QoS Policy Control | | X | |
| Transport marking | X | X | Used for prioritization in the |
| | | | transport network. |
| Charging Data Collection | | X | |
| Packet classification of downlink (DL) | FFS | FFS | Some companies think the |
| packets for QoS differentiation on the | | | QoS classification for QoS |
| Radio | | | differentiation of DL packets |
| | | | is performed in RAN. |
| QoS differentiation and verification for | FFS | FFS | Some companies think the |
| uplink (UL) packets | | | QoS verification for UL |
| | | | packets is performed in RAN |
| | | | and/or CN. |

The RRC Inactive state is based on:
At transition from RRC_CONNECTED to RRC_INACTIVE storing the UE Context in the RAN and in the UE
While in RRC_INACTIVE keeping the N2 UE connection and N3 user plane resources established
The UE CM state in the UE and in the Authentication Management Field (AMF) is CM-CONNECTED
The stored UE Context data is used to fast resume the RRC connection and enter RRC_CONNECTED state

This above requires a new RRC procedure referred here as ‘Connection Suspend procedure’ supporting a RRC_CONNECTED to RRC_INACTIVE state transition and a new procedure referred here as ‘Connection Resume procedure’ required for a transition from RRC_INACTIVE to RRC_CONNECTED state.

Proposal 1: Two new procedures are needed to support RRC_CONNECTED to RRC_INACTIVE (Connection Suspend) and RRC_INACTIVE to RRC_CONNECTED state transitions (Connection Resume) where RAN notifies the AMF about the RRC state of the UE. Both procedures shall be documented in the Technical Specification (TS) 23.502.

The transition from RRC_INACTIVE to RRC_CONNECTED state may take place at the same old serving RAN node where the UE Context is stored or at a different, new serving RAN node. In the latter case, the UE Context must be retrieved from the old serving RAN node where it is currently stored. There are two scenarios:
1. The new serving RAN node has an established Xn interface with the old serving RAN node.
2. The new serving RAN node does not have an established Xn interface with the old serving RAN node.

In scenario 1, the new serving RAN node retrieves the UE Context by means of a new procedure referred to here as ‘UE Context Retrieval via the radio access network’. Furthermore, if the Resume procedure was triggered by paging from the old serving RAN node, the data that triggered paging buffered at old serving RAN node must also be forwarded to the new serving RAN node.

Proposal 2: A new procedure for a UE Context retrieval via the radio access network, i.e. via the Xn interface shall be introduced and documented in TS 23.502. This procedure shall also support data forwarding.

In scenario 2, the new serving RAN nodes retrieves the UE Context by means of control plane signaling via the AMF. An AMF in the pool the RAN is connected to that is eligible to be used as a relay can be chosen. The AMF uses the old serving RAN node ID included in the Resume ID provided by the UE at Connection Resume procedure to identify and request the UE Context transfer from the old serving RAN node. Furthermore, if the Resume procedure was triggered by paging from the old serving RAN node, the data that triggered paging buffered at the old serving RAN node must also be forwarded to the new serving RAN node. This is achieved by providing the ‘Downlink forwarding address’ from the new serving RAN node to the old serving RAN node.

Proposal 3: A new procedure for a UE Context retrieval via the 5GC, i.e. via the N2 interface shall be introduced and documented in TS 23.502. This procedure shall also support data forwarding by means of providing the ‘DL data forwarding address’ allocated by the new serving RAN node to the old service RAN node.

RAN WG2 agreed to introduce the ‘RAN Paging Area’ where it is assumed that it will be aligned with the LC agreement where that area can be configured in the UE by RAN as a:
List of cells
TA List

Hence configuring the RAN Paging Area of the same size as UE's Registration Area rather than opting for a smaller ‘cell list based’ RAN Paging Areas limited by Xn availability, has the benefit of keeping the signalling overhead and UE battery lifetime while in RRC_INACTIVE state on par with the CM-IDLE state as documented as an objective by SA2 in the TR 23.799.

Using the Registration Area (TA List) implies that the RAN Paging Area can reach outside of the Xn connectivity of the old serving RAN node. Hence RAN Paging shall not be limited by Xn connectivity. To overcome the Xn connectivity limitation at RAN Paging, the proposed solution is to introduce a new procedure, RAN Paging relay via the 5GC procedure. In this procedure old serving RAN sends the N2 Paging message to the AMF and requests the serving AMF to relay the N2 Paging message to the relevant RAN nodes that are in the UE's Registration Area. RAN provides in the Paging Relay Request UE's Registration Area assumed to be known in the RAN to ensure that RAN, when paging via Xn, does not page outside UE's registration area.

Proposal 4: A new procedure for a RAN Paging Relay via the 5GC, i.e. via the N2 interface shall be introduced and documented in TS 23.502. This procedure shall also support data forwarding by means of providing the DL data forwarding address' allocated by the new serving RAN node to the old service RAN node.

The above proposed procedures are documented in the attached CR proposal S2-172300.

In addition to using the 5GC and in particular AMFs to relay paging and context retrieval, the RAN may also use an initial AMF for selection of another AMF appropriate to support the slices required by the UE. See TS 23.502 clause 4.2.2.2.3 Registration with AMF relocation: When an AMF receives a Registration request, the AMF may need to reroute the Registration request to another AMF, e.g. due to network slicing is used and the initial AMF is not the appropriate AMF to serve the UE.

Currently the selection by RAN of the initial AMF is described as: If the (R)AN cannot select an appropriate AMF, it forwards the Registration Request to an AMF selected according to local policies. If the selected AMF cannot serve the UE, the selected AMF selects an appropriate AMF for the UE.

In step 2 of the registration procedure (step 2 in FIG. 4.2.2.2-1) it is stated that “If the (R)AN cannot select an appropriate AMF, it forwards the Registration Request to an AMF selected according to local policies.” However, the selected AMF must be allowed to get the authentication keys for the UE to authenticate the UE and if network slicing is used, also be allowed to fetch necessary data from the Unified Data Management (UDM) to be able to make a decision on reroute and to select target AMF. This means that the selected new/initial AMF must be an AMF trusted by the slice that is owning the authentication keys in the AUSF and the subscription data in the UDM, the selection controlled by local policies in (R)AN should comply to this.

Proposal 3: Clarify that if network slicing is used and if the (R)AN cannot select an appropriate AMF, then the selected AMF should be an AMF trusted by all supported slices to be allowed to request authentication from AUSF and subscription data from UDM.

If a SUPI is included or the Temporary User ID does not indicate a valid AMF the (R)AN, based on (R)AT and Network Slice Selection Assistance Information (NSSAI), if available, selects an AMF.

The (R)AN selects an AMF as described in TS 23.501 [2], clause X.

If the (R)AN cannot select an appropriate AMF, it forwards the Registration Request to an AMF selected according to local policies. The local policies should assure that the selected initial/new AMF is trusted by all possible target slices, in the current location for the UE, to be allowed to fetch authentication keys from AUSF

With introduction of “CM-Connected and RRC inactive” and with absence of Xn-interface there is a risk of getting paging requests and context retrieval requests relayed via an arbitrary selected AMF. In case of having a 5GC network supporting slicing such request may then be routed via AMFs belonging to slices handling sensitive traffic e.g., mission critical traffic or emergency traffic. The routed requests may even be related to UEs not served by the slices in which the relaying AMFs are deployed. A consequence could in worst case be that those AMFs gets congested by traffic not belong to them. Another consequence is that information may be exposed to slices not entitled to the information. Slice isolation is not achieved.

In case of having a 5GC network supporting shared network requests may be routed via AMFs belonging to an operator not serving the UE. Operator network isolation is not achieved. Therefore, improved systems and methods for relaying information in 5GC are needed.

### SUMMARY

Systems and methods for relaying information in Fifth Generation Core Networks (5GCs) are provided. In some embodiments, a method of operation of a network node in a wireless communication network includes receiving an establishment request message from a Radio Access Network (RAN) node and sending an establishment response message to the RAN node where the establishment response message includes an indication of a relay capability of the network node. In this way, slice isolation and operator separation are enhanced and load distribution is better controlled.

In some embodiments, the indication of a relay capability of the network node includes an indication that the network node is eligible to handle a relay of paging requests. In some embodiments, the indication of a relay capability of the network node includes an indication that the network node is eligible to handle a relay of wireless device context retrieval requests. In some embodiments, the indication that the network node is eligible to handle a relay of paging requests and the indication that the network node is eligible to handle a relay of wireless device context retrieval requests are included in a generic relay eligibility and/or capability indication. In some embodiments, the indication of a relay capability of the network node includes an indication that the network node is eligible to act as an initial network node.

In some embodiments, a network node for a cellular communications network includes at least one processor and memory. The memory includes instructions executable by the at least one processor whereby the network node is operable to: receive an establishment request message from a RAN node and send an establishment response message to the RAN node where the establishment response message includes an indication of a relay capability of the network node.

In some embodiments, a method of operation of a radio access node in a wireless communication network includes selecting a network node to relay a request where the network node is selected based on an indication of a relay capability of the network node.

In some embodiments, selecting the network node includes selecting the network node to relay the request where the network node from a plurality of network nodes that have indicated eligibility for relay of requests.

In some embodiments, selecting the network node from the plurality of network nodes that have indicated eligibility for relay of requests includes performing a weighted random distribution of the plurality of network nodes that have indicated eligibility for relay of requests and selecting the network node to relay the request where the network node that has the highest weighted value.

In some embodiments, the request is a paging request and selecting the network node to relay the request includes selecting the network node to relay the request that has indicated it is eligible to handle a relay of paging requests.

In some embodiments, the request is a context retrieval request and selecting the network node to relay the request includes selecting the network node to relay the request that has indicated it is eligible to handle a relay of wireless device context retrieval requests.

In some embodiments, a radio access node includes at least one processor and memory. The memory includes instructions executable by the at least one processor whereby the radio access node is operable to select a network node to relay a paging request where the network node is selected based on an indication of a relay capability of the network node.

In some embodiments, receiving the establishment request message from the RAN node includes receiving a N2 establishment request message from the RAN node. In some embodiments, the network node is an Access and Mobility Management Function (AMF). In some embodiments, the wireless communication network is a Fifth Generation (5G) wireless communication network.

In some embodiments, receiving the establishment request message from the RAN node includes receiving a N2 establishment request message from the RAN node. In some embodiments, the network node is an Access and Mobility Management Function (AMF). In some embodiments, the wireless communication network is a Fifth Generation (5G) wireless communication network.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary wireless communication system according to some embodiments of the present disclosure;

FIG. 2a illustrates some of the functional blocks within a conventional Fifth Generation (5G) network architecture and the named interfaces between them according to some embodiments of the present disclosure;

FIG. 2b illustrates some of the functional blocks within a conventional Fifth Generation (5G) network architecture and the named reference points and interfaces between them according to some embodiments of the present disclosure;

FIG. 3 shows the scenario when an AMF or similar access and mobility management entity connects to a Radio Access Network (RAN) node according to some embodiments of the present disclosure;

FIG. 4 shows the scenario of paging relay via AMF or similar access management entity from a serving RAN node to one or several non-serving RAN nodes according to some embodiments of the present disclosure;

FIG. 5 shows the scenario of UE Context retrieval using relay via AMF or similar access and mobility management entity from a new serving RAN node to the old serving RAN node according to some embodiments of the present disclosure;

FIG. 6 shows the scenario of reroute via initial AMF or similar access management entity to a target AMF or similar target access and mobility management entity according to some embodiments of the present disclosure;

FIG. 7 is a schematic block diagram of a network node (e.g. a core network entity, e.g. such as e.g. a AMF, a UPF, a NRF, a UDM, a AUSF, a RAN node, etc.) according to some embodiments of the present disclosure;

FIG. 8 is a schematic block diagram of a virtualized network node according to some embodiments of the present disclosure;

FIG. 9 is a schematic block diagram of a network node (e.g. a core network entity) according to some embodiments of the present disclosure;

FIG. 10 is a schematic block diagram of a wireless device according to some embodiments of the present disclosure;

FIG. 11 is a schematic block diagram of a wireless device according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

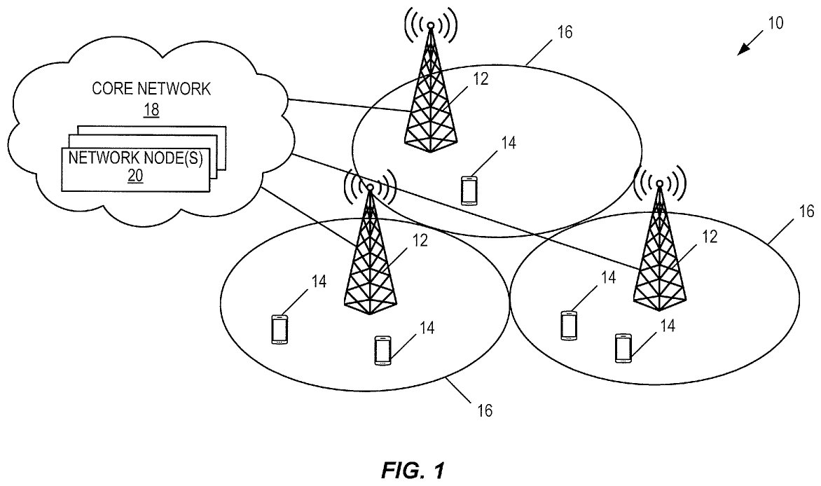

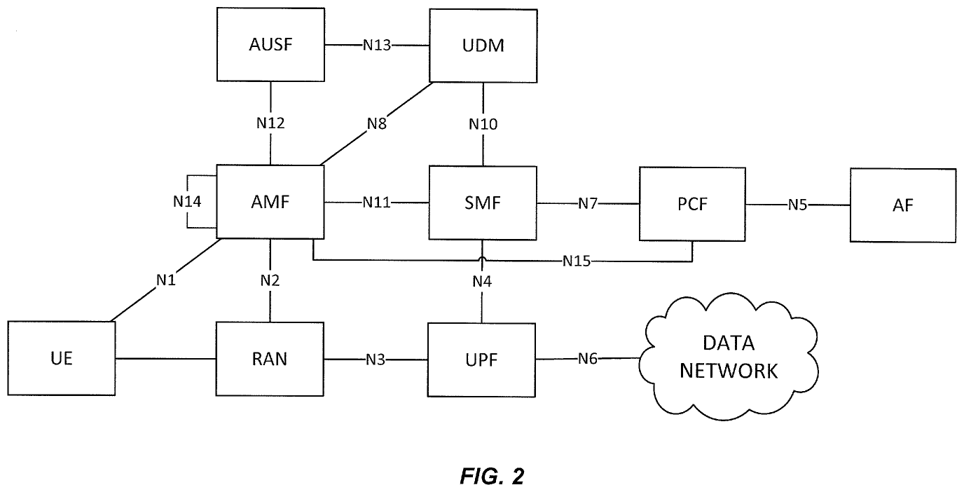

FIG. 1 illustrates one example of a wireless communication system 10 in which embodiments of the present disclosure may be implemented. The wireless communication system 10 may be a cellular communications system such as, for example, a 5G New Radio (NR) network or an LTE cellular communications system. As illustrated, in this example, the wireless communication system 10 includes a plurality of radio access nodes 12 (e.g., eNBs, 5G base stations which are referred to as gNBs, or other base stations) and a plurality of wireless communication devices 14 (e.g., conventional UEs, Machine Type Communication (MTC)/Machine-to-Machine (M2M) UEs). The wireless communication system 10 is organized into cells 16, which are connected to a core network 18 via the corresponding radio access nodes 12. The radio access nodes 12 are capable of communicating with the wireless communication devices 14 (also referred to herein as wireless devices 14 or UEs 14) along with any additional elements suitable to support communication between wireless communication devices or between a wireless communication device and another communication device (such as a landline telephone). The core network 18 includes one or more network node(s) 20. In some embodiments, the network nodes 20 may comprise, for example, any of the nodes shown in FIG. 2.

FIG. 2a illustrates some of the functional blocks (also called Network Functions, NFs) within a 5G network architecture and the named interfaces between them. FIG. 2a includes an Authentication Server Function (AUSF), a Unified Data Management (UDM) block, an Access and Mobility Management Function (AMF), a Session Management Function (SMF), a Policy Control Function (PCF), an Application Function (AF), a UE, a Radio Access Network (RAN), a User Plane Function (UPF), and a Data Network (DN). For simplicity, the RAN will be hereinafter referred to as “the RAN”. The named interfaces (e.g. N1, N2, N3, N4, N5, N6, N7, N8, N10, N11, N12, N13 etc) are logical connections between entities.

FIG. 2b illustrates a 5G network architecture using service-based interfaces between the NFs in the control plane, instead of the point-to-point reference points/interfaces used between the NFs in the control plane of the 5G network architecture of FIG. 2a. In FIG. 2b the service based interfaces are indicated by the letter “N” followed by the name of the NF, e.g. Namf for the service based interface of the AMF and Nsmf for the service based interface of the SMF etc. The service(s) etc. that a NF provides to other authorized NFs is/are exposed to the authorized NFs through the service-based interface of the NF in question.

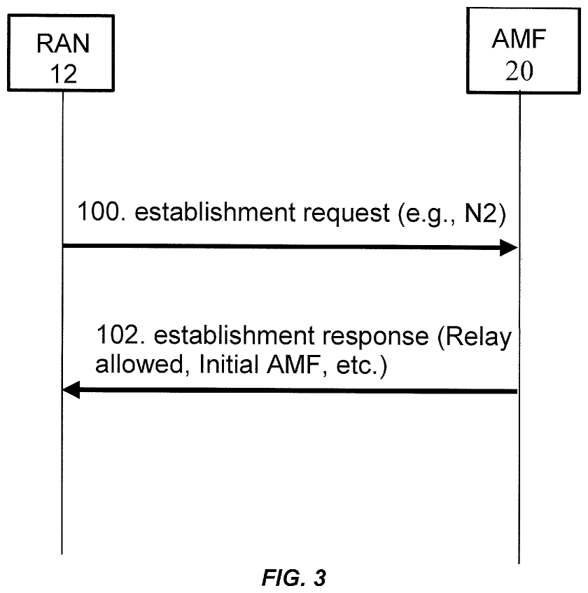

FIG. 3 shows the scenario when an AMF 20 connects to a RAN node 12. The RAN node 12 requests set up of an N2 connection towards an AMF 20 by sending an N2 establishment request (step 100). The AMF 20 responds by sending an N2 establishment respond message (step 102). In some embodiments, in that message, the AMF 20 declares its eligibility to handle relay of paging requests and relay of UE 14 context retrieval request as well as relaying of the UE Context. In some embodiments, the Relay Allowed parameter includes some combination of two indications: 1) Paging relay and 2) Context relay. The Initial AMF parameter indicates if this AMF 20 may serve as initial AMF 20 for reroute due to slicing, for example.

By indicating this, the AMF declares that it is trusted and allowed to fetch the necessary reroute information and that it is capable of handling the extra load caused by relay and reroute. It also declares that it is allowed to handle relayed information.

Some of the above indications may be merged into a generic Relay eligibility and/or capability.

An alternative to this dynamic exchange of capability is of course to make it configurable in the RAN or letting RAN fetch the information via another source e.g. an NRF.

The above solution takes care of a situation with only one operator but with a shared network it will also be necessary to separate relay and reroute per operator network. For selection of initial AMF it is anticipated that the UE, in its registration request, indicates selected PLMN and that RAN thereby may perform a separation of signaling per operator. As this is similar to what is already used today in 4G it is no novelty. For paging relay RAN will, at use of “CM-Connected and RRC inactive”, also know what operator the UE belongs to and thereby operator separation may be achieved.

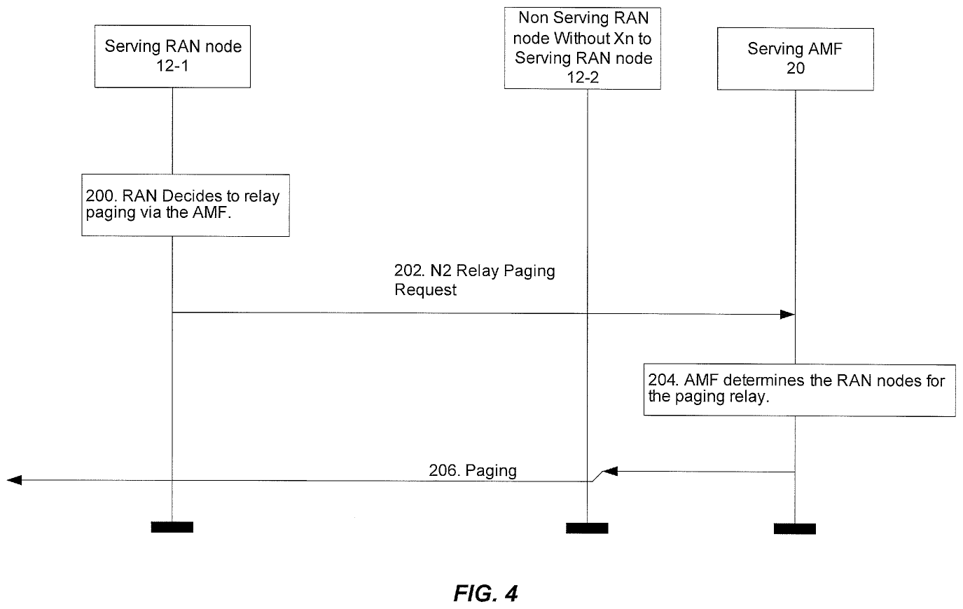

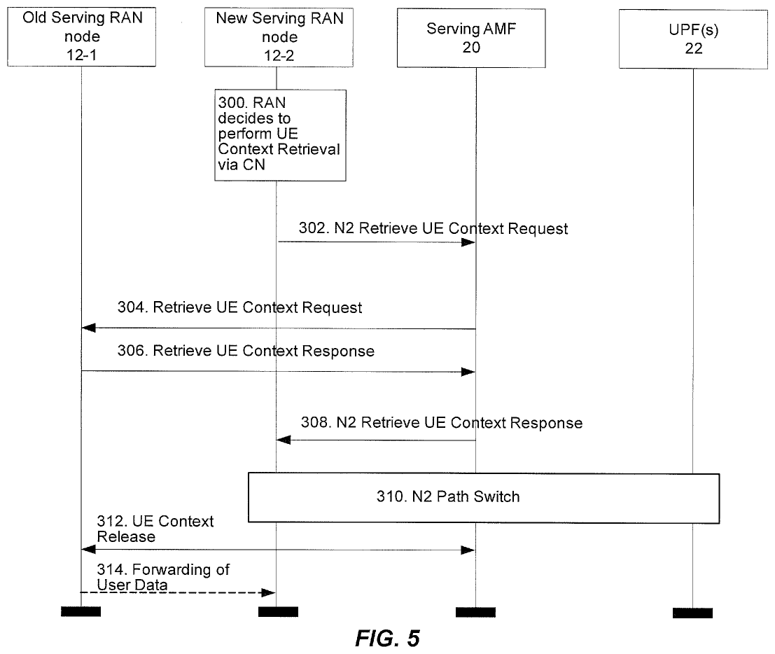

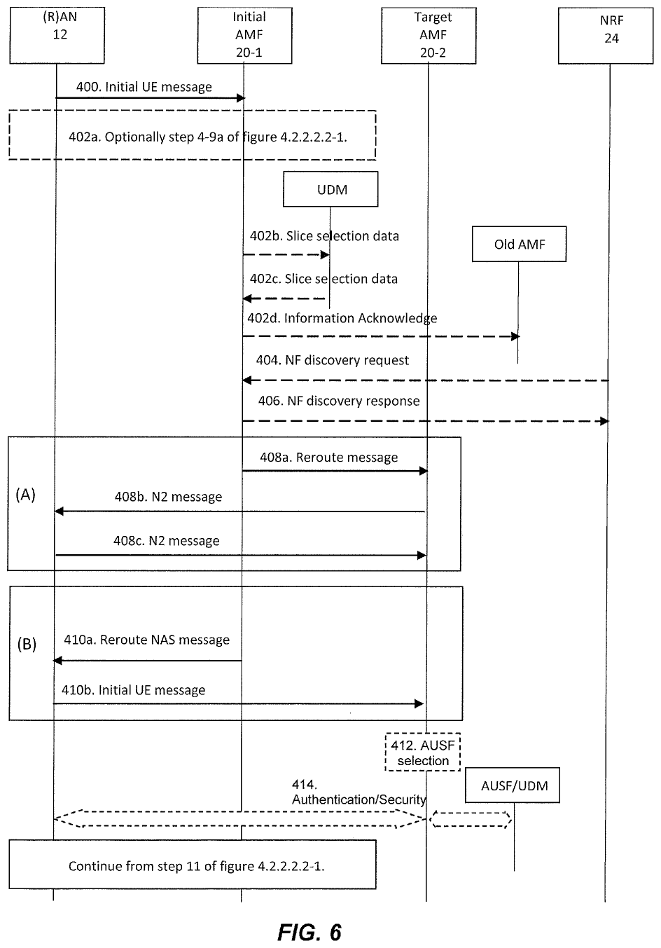

FIG. 4 shows the scenario of paging relay via AMF from a serving RAN node to one or several non-serving RAN nodes. The serving RAN node decides to relay the paging via the 5GC through AMF 20 (step 200). AMF is selected based on the Relay allowed indication given in the N2 establishment message. Only AMFs indicating eligibility for relay of paging request may be candidates. Among the eligible AMFs the RAN node may e.g. perform a weighted random distribution (relative weight may be received at N2 establishment).

Serving RAN to AMF: N2 Relay Paging Request (N2 Paging, Registration Area). The serving RAN node requests the serving AMF to relay the paging message to the RAN nodes in UE's Registration Area (step 202). The AMF, based on received UE's Registration Area, selects the RAN nodes to which the paging message will be relayed (step 204). In some embodiments, the AMF will not trigger paging repetition on its own. AMF to RAN: N2 Paging. The AMF relays paging to the RAN nodes in UE's Registration Area (step 206).

FIG. 5 shows the scenario of UE Context retrieval using relay via AMF from a new serving RAN node to the old serving RAN node. The New Serving RAN node realises that it has no Xn connection to a RAN node with the identity indicated in the Resume ID and decides to perform the Context Retrieval via Core Network procedure (step 300). The AMF is selected based on the Relay allowed indication given in the N2 establishment message. Only AMFs indicating eligibility for relay of UE Context request may be candidates. Among the eligible AMFs the RAN node may e.g. perform a weighted random distribution (relative weight may be received at N2 establishment). Resume ID includes an operator indication giving the operator network to select in case of shared networks either as by use of separate bits or by use of Resume ID ranges per operator. Alternatively, registered PLMN can be provided during the Resume procedure in additional message(s)/transport blocks.

RAN to AMF: N2 Retrieve UE Context Request (Old RAN ID (contained in the Resume ID), Resume ID, new RAN ID). The RAN 12-2 requests an AMF within a pool to which it is connected, to resolve the RAN node identity (step 302). This AMF node doesn't necessarily need to be the AMF serving the UE. Respective signalling is performed in a connection-less and the AMF stateless manner. If the AMF is able to resolve the address of the indicated Old RAN ID, it forwards the request to that node.

AMF to Old Serving RAN: Retrieve UE Context Request (Old RAN ID, New RAN ID, Resume ID). The AMF forward the request to the Old Serving RAN (step 304). Old Serving RAN to AMF: Retrieve UE Context Response (Old RAN ID, New RAN ID, Resume ID, UE Context). The Old Serving RAN node provides UE Context Data (step 306).

The AMF to RAN: N2 Retrieve UE Context Response (Resume ID, UE Context). The AMF 20 forwards the information received in step 306 to the New Serving RAN 12-2 (step 308). RAN to AMF: N2 Path Switch (no Xn indicator, DL forwarding address). The New Serving RAN node triggers the path switch procedure as if it would have received UE context data via Xn interface and indicates to the AMF that no Xn connection is available towards the Old Serving RAN node (step 310).

In some embodiments, the message also contains the DL forwarding addresses. AMF to Old Serving RAN: N2 UE Context Release. The AMF node performs the N2 UE Context Release procedure (step 312) (as the New Serving RAN node is not able to trigger it via Xn) and optionally provides the DL forwarding addresses for the user plane data. If necessary, forwarding of user data takes place (step 314).

However, for UE Context retrieval an operator indication may need to be encoded in the Resume ID provided by the UE, thereby providing RAN with the possibility to separate retrieval signaling per operator network. With e.g. 6-8 sharing operators 3 bits of the Resume ID may be used to indicate serving operator. Further ways to inform the network about UE's registered PLMN can be provided during the Resume procedure in additional message(s)/transport blocks. Alternatively, this information can be encoded as a Resume ID range.

FIG. 6 shows the scenario of reroute via initial AMF to a target AMF. The scenario is initiated by a Registration request from a UE via a RAN node to the initial AMF. The initial AMF and the target AMF register its capability at the NRF 24. In some embodiments, Steps 1 and 2 of FIG. 4.2.2.2.2-1 have occurred, and the (R)AN sends the Registration request message within an Initial UE message to the initial AMF (step 400). Initial AMF is selected based on the Initial AMF indication given in the N2 establishment message. Only AMFs indicating eligibility, to act as initial AMF for reroute due to slicing, may be candidates. Among the eligible AMFs the RAN node may e.g. perform a weighted random distribution (relative weight may be received at N2 establishment).

If the AMF needs the SUPI and/or UE's subscription information to decide whether to reroute the Registration request or if the Registration request was not sent integrity protected or integrity protection is indicated as failed, then AMF performs step 4 to 9a of FIG. 4.2.2.2.2-1 (step 402a). In this case, if the initial AMF 20-1 needs UE's subscription information to decide whether to reroute the Registration request and UE's subscription information was not provided by old AMF, then initial AMF request UE's slice selection data from UDM (step 402b). The UDM responds with slice selection data to initial AMF 20-1 (step 402c).

The AMF obtains the Allowed NSSAI based on the Requested NSSAI, UE subscription, and local policies. If the initial AMF is not suitable for supporting the Allowed NSSAI, the Registration Request is rerouted. The initial AMF 20-1 decides to reroute the NAS message to another AMF. The initial AMF 20-1 sends a reject indication to the old AMF (step 402d). The old AMF continues as if the Information Request was never received.

If the initial AMF 20-1 does not locally store the target AMF address, the initial AMF sends an NF discovery request to the NRF 24 to find a proper target AMF which has required NF capabilities to serve the UE (step 404). The NF type is set to AMF. If network slicing is used, NSSAI is included in the NF discovery request.

The NRF 24 replies with a set of potential target AMFs 20 and their capabilities (step 406). Based on the information about registered NFs and required capabilities, a target AMF is selected by the initial AMF.

If the initial AMF, based on local policy and subscription information, determines to forward the NAS message to the target AMF directly, the initial AMF sends a Reroute NAS message to the target AMF 20-2 (step 408a). The Reroute NAS message includes the information enabling (R)AN to identify the N2 terminating point and the NAS message carried at Step 400, and optionally the UE's SUPI and MM Context. If network slicing is used and the initial AMF determines the Allowed NSSAI as described at step 402c, the Allowed NSSAI is included. The target AMF then updates the (R)AN with a new updated N2 termination point for the UE (step 408b), the (R)AN acknowledges the updated N2 termination point (step 408c). In some embodiments, Steps 408b and 408c can occur separately or as part of the first subsequently required N2 interaction.

If the initial AMF, based on local policy and subscription information, determines to forward the NAS message to the target AMF via RAN, the initial AMF sends a Reroute NAS message to the RAN (step 410a) indicating reroute due to slicing. The Reroute NAS message includes the information about the target AMF and the Registration request message carried at Step 400, and optionally the UE's SUPI and MM Context. If network slicing is used and the initial AMF determines the Allowed NSSAI as described at Step 402c, the Allowed NSSAI is included in the Reroute NAS message. The RAN sends the Initial UE message to the target AMF (step 410b) indicating reroute due to slicing.

The target AMF may decide to invoke an AUSF (step 412). In that case, according to some embodiments, the target AMF, shall be based on SUPI, select an AUSF as described in TS 23.501 [2], clause X. The AUSF shall initiate authentication of the UE and NAS security functions (step 414). The authentication and security are performed as described in clause X. In some embodiments, UDM is selected in this step in various ways. In some embodiments either the AUSF or the AMF initiates the authentication.

After receiving the Registration request message transmitted at step 408a or step 410b, the target AMF, based on rerouting due to slicing, continues with the Registration procedure from step 11 of FIG. 4.2.2.2.2-1 (with the target AMF corresponding to the new AMF).

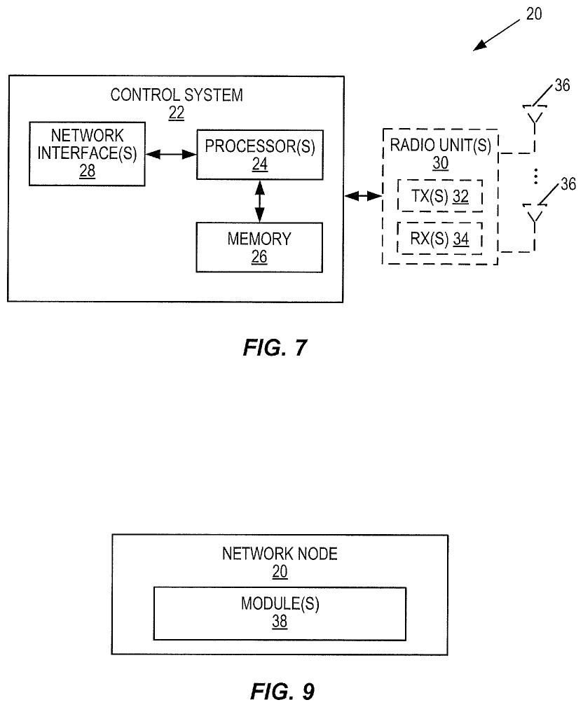

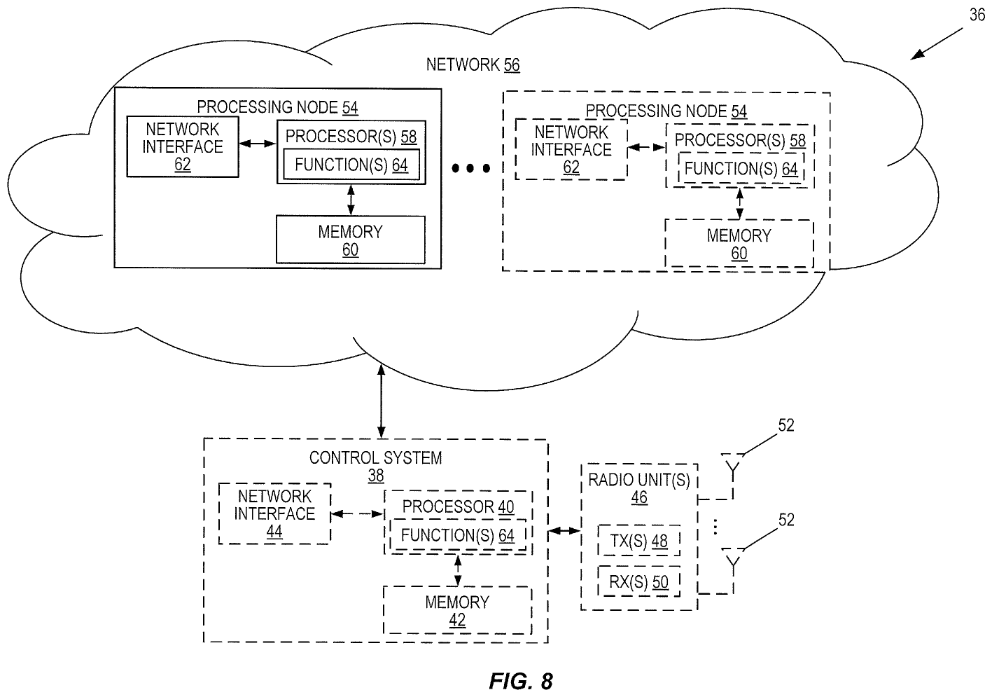

FIG. 7 is a schematic block diagram of a network node 20 (e.g. a network entity, e.g. such as e.g. an AMF, a UPF, a NRF, a UDM, an AUSF, a RAN node, etc.) according to some embodiments of the present disclosure. As illustrated, the network node 20 includes a control system 22 that includes circuitry comprising one or more processors 24 (e.g., Central Processing Units (CPUs), Application Specific Integrated Circuits (ASICs), Digital Signal Processors (DSPs), Field Programmable Gate Arrays (FPGAs), and/or the like) and memory 26. In the embodiment illustrated in FIG. 8, the control system 22 also includes a network interface 28. In embodiments in which the network node 20 is a RAN, the network node 20 also includes one or more radio units 30 that each include one or more transmitters 32 and one or more receivers 34 coupled to one or more antennas 36. In some embodiments, the functionality of the network node 20 described above may be fully or partially implemented in software that is, e.g., stored in the memory 26 and executed by the processor(s) 24.

FIG. 8 is a schematic block diagram that illustrates a virtualized embodiment of the network node 36 (e.g., the radio access node 12 or a network node 20) according to some embodiments of the present disclosure. As used herein, a “virtualized” network node 36 is a network node 36 in which at least a portion of the functionality of the network node 36 is implemented as a virtual component (e.g., via a virtual machine(s) executing on a physical processing node(s) in a network(s)). As illustrated, the network node 36 optionally includes the control system 38, as described with respect to FIG. 9. In addition, if the network node 36 is the radio access node 12, the network node 36 also includes the one or more radio units 46, as described with respect to FIG. 9. The control system 38 (if present) is connected to one or more processing nodes 54 coupled to or included as part of a network(s) 56 via the network interface 44. Alternatively, if the control system 38 is not present, the one or more radio units 46 (if present) are connected to the one or more processing nodes 54 via a network interface(s). Alternatively, all of the functionality of the network node 36 (e.g., all of the functionality of the radio access node 12) described herein may be implemented in the processing nodes 54. Each processing node 54 includes one or more processors 58 (e.g., CPUs, ASICs, DSPs, FPGAs, and/or the like), memory 60, and a network interface 62.

In this example, functions 64 of the network node 36 (e.g., the functions of the radio access node 12) described herein are implemented at the one or more processing nodes 54 or distributed across the control system 38 (if present) and the one or more processing nodes 54 in any desired manner. In some particular embodiments, some or all of the functions 64 of the network node 36 described herein are implemented as virtual components executed by one or more virtual machines implemented in a virtual environment(s) hosted by the processing node(s) 54. As will be appreciated by one of ordinary skill in the art, additional signaling or communication between the processing node(s) 54 and the control system 38 (if present) or alternatively the radio unit(s) 46 (if present) is used in order to carry out at least some of the desired functions. Notably, in some embodiments, the control system 38 may not be included, in which case the radio unit(s) 46 (if present) communicates directly with the processing node(s) 54 via an appropriate network interface(s).

FIG. 9 is a schematic block diagram of a network node 20 (e.g. a core network entity) according to some other embodiments of the present disclosure. In this embodiment, the network node 20 includes one or more modules 38, each of which is implemented in software. The module(s) 38 provide the functionality of the network node 20 described herein.

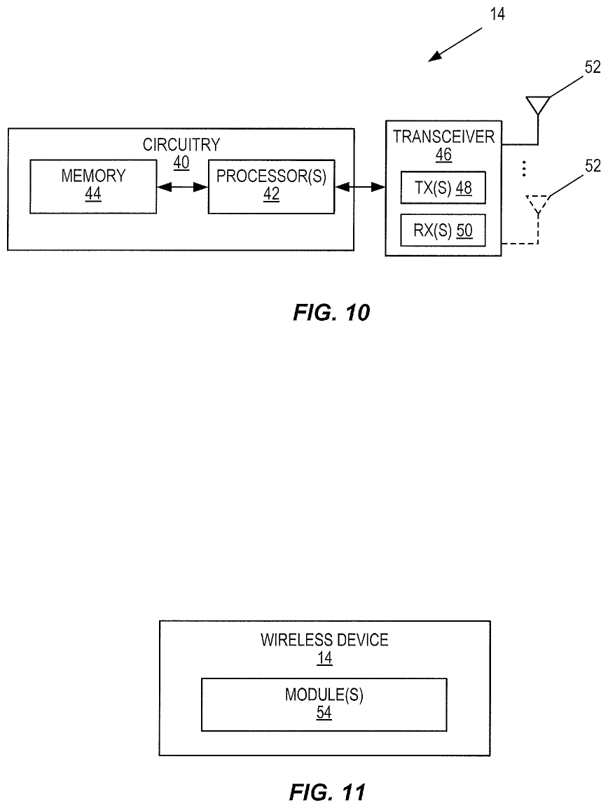

FIG. 10 is a schematic block diagram of a wireless device 14 according to some embodiments of the present disclosure. As illustrated, the wireless device 14 includes processing circuitry 40 comprising one or more processors 42 (e.g., CPUs, ASICs, FPGAs, DSPs, and/or the like) and memory 44. The UE 14 also includes one or more transceivers 46 each including one or more transmitters 48 and one or more receivers 50 coupled to one or more antennas 52. In some embodiments, the functionality of the wireless device 14 described above may be implemented in hardware (e.g., via hardware within the circuitry 40 and/or within the processor(s) 42) or be implemented in a combination of hardware and software (e.g., fully or partially implemented in software that is, e.g., stored in the memory 44 and executed by the processor(s) 42).

In some embodiments, a computer program including instructions which, when executed by the at least one processor 42, causes the at least one processor 42 to carry out at least some of the functionality of the wireless device 14 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of a wireless device 14 according to some other embodiments of the present disclosure. The UE 14 includes one or more modules 54, each of which is implemented in software. The module(s) 54 provide the functionality of the wireless device 14 described herein.

### EXAMPLE EMBODIMENTS

While not being limited thereto, some embodiments described above may be summarized in the following manner:

1. A method of operation of a network node (20) in a wireless communication network (10), comprising:
receiving (100) an establishment request message from a Radio Access Network, RAN, node (12); and
sending (102) an establishment response message to the RAN node where the establishment response message comprises an indication of a relay capability of the network node (20).
   2. The method of embodiment 1 wherein the indication of the relay capability of the network node (20) comprises an indication that the network node (20) is eligible to handle a relay of paging requests.
   3. The method of any of embodiments 1 through 2 wherein the indication of a relay capability of the network node (20) further comprises an indication that the network node (20) is eligible to handle a relay of wireless device (14) context retrieval requests.
   4. The method of embodiment 3 wherein the indication that the network node (20) is eligible to handle a relay of paging requests and the indication that the network node (20) is eligible to handle a relay of wireless device (14) context retrieval requests are comprised in a generic relay eligibility and/or capability indication.
   5. The method of any of embodiments 1 through 4 wherein the indication of a relay capability of the network node (20) further comprises an indication that the network node (20) is eligible to act as an initial network node (20).
   6. The method of any of embodiments 1 through 5 wherein receiving the establishment request message from the RAN node (12) comprises receiving a N2 establishment request message from the RAN node (12).
   7. The method of any of embodiments 1 through 6 wherein the network node (20) is an Access and Mobility Management Function, AMF.
   8. The method of any of embodiments 1 through 7 wherein the wireless communication network (10) is a Fifth Generation, 5G, wireless communication network.
   9. A network node (20) for a cellular communications network (10), comprising:
at least one processor (24); and
memory (26) comprising instructions executable by the at least one processor (24) whereby the network node (20) is operable to:
   receive an establishment request message from a Radio Access Network, RAN, node (12); and
   send an establishment response message to the RAN node where the establishment response message comprises an indication of a relay capability of the network node (20).
      10. The network node (20) of embodiment 9 wherein the network node (20) is further operable to perform the method of any one of embodiments 2 through 8.
      11. A method of operation of a radio access node (12) in a wireless communication network (10), comprising:
selecting (200) a network node (20) to relay a request where the network node (20) is selected based on an indication of a relay capability of the network node (20).
   12. The method of embodiment 11 wherein selecting the network node (20) comprises:
selecting the network node (20) to relay the request where the network node (20) from a plurality of network nodes (20) that have indicated eligibility for relay of requests.
   13. The method of embodiment 12 wherein selecting the network node (20) from the plurality of network nodes (20) that have indicated eligibility for relay of requests comprises:
performing a weighted random distribution of the plurality of network nodes (20) that have indicated eligibility for relay of requests; and
selecting the network node (20) to relay the request where the network node (20) that has the highest weighted value.
   14. The method of any of embodiments 11 through 13 wherein the request is a paging request and selecting the network node (20) to relay the request further comprises selecting the network node (20) to relay the request that has indicated it is eligible to handle a relay of paging requests.
   15. The method of any of embodiments 11 through 14 wherein the request is a context retrieval request and selecting the network node (20) to relay the request further comprises selecting the network node (20) to relay the request that has indicated it is eligible to handle a relay of wireless device (14) context retrieval requests.
   16. The method of any of embodiments 11 through 15 wherein the network node (20) is an Access and Mobility Management Function, AMF.
   17. The method of any of embodiments 11 through 16 wherein the wireless communication network (10) is a Fifth Generation, 5G, wireless communication network.
   18. A radio access node (12), comprising:
at least one processor (42); and
memory (44) comprising instructions executable by the at least one processor (42) whereby the radio access node (12) is operable to:
   select a network node (20) to relay a paging request where the network node (20) is selected based on an indication of a relay capability of the network node (20).
      19. The radio access node (12) of embodiment 18 wherein the radio access node (12) is further operable to perform the method of any one of embodiments 12 through 17.

The following acronyms are used throughout this disclosure.
3GPP Third Generation Partnership Project
5G Fifth Generation
5GC Fifth Generation Core Network
AF Application Function
AMF Access and Mobility Management Function
ASIC Application Specific Integrated Circuit
AUSF Authentication Server Function
CPU Central Processing Unit
DN Data Network
DSP Digital Signal Processor
EPC Evolved Packet Core
ePCO enhanced Protocol Configuration Option
EPS Evolved Packet System
E-UTRAN Evolved UMTS Terrestrial Radio Access Network
FPGA Field Programmable Gate Array
GPRN General Packet Radio Network
HO Handover
HSS Home Subscriber Server
M2M Machine to Machine
MME Mobility Management Entity
MTC Machine Type Communication
NR New Radio
PCF Policy Control Function
PCO Protocol Configuration Options
PDN Packet Data Network
PDP Packet Data Protocol
PDU Protocol Data Unit
PGW PDN Gateway
PGW-C PDN Gateway-Control
QoS Quality of Service
RAN Radio Access Network
SGSN Serving GPRN Support Node
SGW Signaling Gateway
SMF Session Management Function
UDM Unified Data Management
UE User Equipment
UMTS Universal Mobile Telecommunications System
UPF User Plane Function

Those skilled in the art will recognize improvements and modifications to the embodiments of the present disclosure. All such improvements and modifications are considered within the scope of the concepts disclosed herein.

1. A method of operation of a core network entity in a wireless communication network, comprising:
receiving an establishment request message from a Radio Access Network, RAN, node; and
sending an establishment response message to the RAN node where the establishment response message comprises an indication of a relay capability of the core network entity.

2. The method of claim 1 wherein the indication of the relay capability of the core network entity comprises an indication that the core network entity is eligible to handle a relay of paging requests.

3. The method of claim 1 wherein the indication of a relay capability of the core network entity further comprises an indication that the core network entity is eligible to handle a relay of wireless device context retrieval requests.

4. The method of claim 3 wherein the indication that the core network entity is eligible to handle a relay of paging requests and the indication that the core network entity is eligible to handle a relay of wireless device context retrieval requests are comprised in a generic relay eligibility and/or capability indication.

5. The method of claim 1 wherein the indication of a relay capability of the core network entity further comprises an indication that the core network entity is eligible to act as an initial core network entity.

6. The method of claim 1 wherein receiving the establishment request message from the RAN node comprises receiving a N2 establishment request message from the RAN node.

7. The method of claim 1 wherein the core network entity is an Access and Mobility Management Function, AMF.

8. The method of claim 1 wherein the wireless communication network is a Fifth Generation, 5G, wireless communication network.

9. A core network entity for a cellular communications network, comprising:
at least one processor; and
memory comprising instructions executable by the at least one processor whereby the core network entity is operable to:
receive an establishment request message from a Radio Access Network, RAN, node; and
send an establishment response message to the RAN node where the establishment response message comprises an indication of a relay capability of the core network entity.

10. (canceled)

11. A method of operation of a radio access node in a wireless communication network, comprising:
selecting a core network entity to relay a request where the core network entity is selected based on an indication of a relay capability of the core network entity.

12. The method of claim 11 wherein selecting the core network entity comprises:
selecting the core network entity to relay the request where the core network entity from a plurality of core network entities that have indicated eligibility for relay of requests.

13. The method of claim 12 wherein selecting the core network entity from the plurality of core network entities that have indicated eligibility for relay of requests comprises:
performing a weighted random distribution of the plurality of core network entities that have indicated eligibility for relay of requests; and
selecting the core network entity to relay the request where the core network entity that has the highest weighted value.

14. The method of claim 11 wherein the request is a paging request and selecting the core network entity to relay the request further comprises selecting the core network entity to relay the request that has indicated it is eligible to handle a relay of paging requests.

15. The method of any of claim 11 wherein the request is a context retrieval request and selecting the core network entity to relay the request further comprises selecting the core network entity to relay the request that has indicated it is eligible to handle a relay of wireless device context retrieval requests.

16. The method of claim 11 wherein the core network entity is an Access and Mobility Management Function, AMF.

17. The method of claim 11 wherein the wireless communication network is a Fifth Generation, 5G, wireless communication network.

18. A radio access node, comprising:
at least one processor; and
memory comprising instructions executable by the at least one processor whereby the radio access node is operable to:
select a core network entity to relay a paging request where the core network entity is selected based on an indication of a relay capability of the core network entity.

19. (canceled)
